(19) United States
(12) Patent Application Publication
(10) Pub. No.: US 2011/0082794 A1
(43) Pub. Date: Apr. 7, 2011

(54) Client-centric e-health system and method with applications to long-term health and community care consumers, insurers, and regulators

(76) Inventor: Elaine A. Blechman, Boulder, CO (US)

(21) Appl. No.: 12/589,378

(22) Filed: Oct. 22, 2009

Related U.S. Application Data
(63) Continuation-in-part of application No. 10/853,488, filed on May 25, 2004, now abandoned.
Application No. 10/853,488 is a continuation-in-part of application No. 10/431,845, filed on May 8, 2003.
Application No. 10/431,845 is a continuation-in-part of application No. 10/210,127, filed on Aug. 1, 2002, now abandoned.

(51) Int. Cl. G06Q 50/00; H04L 9/32

(52) U.S. Cl. 705/50

(57) ABSTRACT

A patient-centric system and method for accessing personal health records of a patient, stored in relational databases and containing comprehensive records of multiple patients with each patient's records incorporating many different data categories and functions including manual or automated data exchange, consolidation, storage, routing and transmission, consistent with consent directives assigned to authorized users and computer systems of authorized users by the patient or designated representative thereof. The consent directives define privileges of access in each of said data categories and functions within the patients records. The patients records are stored in relational databases hosted by Web servers on a computer network through which the authorized users interact under the control of programming logic consistent with the consent directives assigned by the patient or designated representative thereof.

The present invention is a continuation in part of U.S. patent application Ser. No. 10/853,488 filed May 25, 2004 which itself is a continuation-in-part of Ser. No. 10/431,845 filed on May 8, 2003 and in turn is continuation in part of U.S. patent application Ser. No. 10/210,127 filed on Aug. 1, 2002 and represents a unique client-centric, multi-level, multi-discipline, e-health system (hereinafter “eSystem”) and method.

### FIELD OF THE INVENTION

The invention's software system consists of user interfaces, programming logic, a relational database, and client and superset accounts. The invention's unique software method drives the system—programming logic encodes client-specified user privileges and controls users' exercise of their privileges via the user interface on records in the relational database. The invention's unique features related to multi-level, multi-user data access, integration, privacy, permanence, and portability are expressions of the software system and method. The invention has applications to long-term health and community care consumers, healthcare providers and enterprises, health and malpractice insurers, and entities that regulate healthcare accreditation and financing.

### BACKGROUND OF THE INVENTION

Long-term healthcare consumers. Each person is a long-term healthcare consumer, receiving healthcare services from a changing array of providers and enterprises across the lifespan. The highest-volume consumers of long-term healthcare are the elderly and people with chronic illnesses and disabilities—such as Alzheimer's, asthma, autism, cystic fibrosis, cognitive and developmental disabilities, diabetes, multiple sclerosis, schizophrenia, and spinal cord injury. Regardless of physical or mental status, every consumer is entitled to long-term healthcare in the least restrictive environment with an optimal quality of life for them and the least burden for their family caregivers. Long-term healthcare consumers deal with vast, uncoordinated, ever-changing arrays of providers (e.g., ambulance drivers, dieticians, home healthcare assistants, medical technicians, nurses, pharmacists, physical therapists, physicians, psychologists, religious leaders, social workers) and enterprises (e.g., clinical research organizations, hospitals, hospices, insurance companies, Medicare/Medicaid authorities, mental health centers, nonprofit and religious organizations, pharmaceutical companies, state and federal regulatory agencies). Few long-term healthcare clients or family caregivers have explicit knowledge of all the providers and enterprises that see their records, decide about authorization of expensive procedures, establish and follow through on treatment plans. No existing technology offers a cost-effective means of facilitating client-centric teamwork among geographically remote and organizationally independent providers and enterprises. Not surprisingly, a large body of evidence documents inadequacies in service delivery to long-term healthcare consumers including fatal mistakes.

Community-care consumers. Many people (including long-term healthcare consumers) receive services intended to prolong community residence and prevent congregate care in a hospital, nursing home, or prison. The highest volume consumers of community care (aside from the previously described long-term healthcare consumers) are youths at risk for violence or suicide; juvenile and adult criminal offenders; and substance abusers. These consumers and their family caregivers require community-based services that effectively balance individual rights and public safety. Congregate care outside the community in alternative schools, residential treatment facilities, psychiatric hospitals, boot camps, and prisons multiplies costs to taxpayers, while diminishing individual rights and endangering the public. Community-care consumers constantly deal with vast, uncoordinated, ever-changing arrays of providers. Community-care providers include district attorneys, judges, lawyers, nurses, pharmacists, parole and probation officers, physicians, police officers, religious leaders, school psychologists, school principals, social workers, teachers, therapists. Community-care consumers also deal with vast, uncoordinated, ever-changing sets of enterprises. Community-care enterprises include child protective service agencies, clinical research organizations, halfway houses, homeless shelters, hospitals, hospices, insurance companies, Medicare/Medicaid authorities, mental health centers, nonprofit and religious organizations, pharmaceutical companies, prisons, school systems, sex offender registry, state and federal regulatory agencies, substance abuse testing and treatment centers. Few community-care clients or family caregivers have explicit knowledge of all the providers and enterprises that see their records, decide about foster care placement, choose between in-school suspension and alternative schooling, advise judges, decide about authorization of medical procedures, establish and follow through on treatment and court orders. No existing technology offers a cost-effective means of facilitating client-centric teamwork among geographically remote and organizationally independent providers and enterprises. Not surprisingly, a large body of evidence documents inadequate delivery of community-care to at-risk youths who later commit school shootings and parent murders, and to at-risk adults who later commit child neglect, abuse, and murder.

Common dilemmas in long-term healthcare and community care. Common dilemmas in long-term health care and community care include fragmented service delivery, medical mistakes and malpractice, poor outcomes related to morbidity, mortality, rehospitalization, repeat institutionalization, recidivism, client abuse and neglect, inadequate consumer and family involvement, and fraudulent billing.

### Unique Nature of Present Invention

The present invention is a unique client-centric, multi-level, multi-discipline, e-health system (hereinafter “eSystem”) and method. The invention's software system consists of user interfaces, programming logic, a relational database, and client and superset accounts. The invention's unique software method drives the system—programming logic encodes client-specified user privileges and controls users' exercise of their privileges via the user interface on records in the relational database. The invention's unique features related to multi-level, multi-user data access, data integration, data permanence, data privacy, and data portability are expressions of the software system and method. The invention's system, methods, and features permit unique applications to long-term health and community care consumers, healthcare providers and enterprises, health and malpractice insurers, and entities that regulate healthcare accreditation and financing. Due to its system, method, features, and applications, the invention has unique advantages compared to conventional enterprise-centric electronic information systems.

### DEFINITIONS OF TERMS

Definitions of key terms in this document are listed below.

Client account. Each consumer has a client account in the eSystem relational database. Either the consumer (the named client on the account) or the consumer's legal agent (e.g., parent, legal guardian, client-designated family caregiver) authorizes user access to the account and defines each user's access privileges to selected data categories and data functions in the client account. Authorized client account users consistent with their privileges may access a variety of data categories (e.g., criminal, educational, health insurance, legal, medical, mental health, occupational, substance abuse) and then perform a variety of data functions (e.g., view, search, update, edit, save, retire, aggregate, and restore).

Client-account user interface. When an authorized user on an eSystem client account logs on to the eSystem with a valid logon ID and password, the eSystem displays user interface or Web pages consistent with the user's access privileges and preferences. The user interface page includes buttons, data-entry fields, and other devices that allow the user to exercise authorized privileges within the account. These privileges permit users to view, search, update, edit, save, retire, aggregate, and restore information. For example, FIG. 3 displays a series of buttons at the left from “My Home” at the top left to “Emergency Procedures” at the bottom left. Each button corresponds to a data category. The user who accessed this page has privileges related to each of these data categories. Users with lesser privileges would see fewer buttons on the left of this interface page. FIG. 3 displays an “Add New Record” button below the schedule. This button corresponds to a data function, adding an event to the schedule. The user who accessed this page has privileges related to this function. Users with lesser privileges might be able to view the schedule page but would not have access to the “Add New Record” button.

Client-centric system. In a client-centric system, consumers regulate access to their personal information in their client accounts.

Consumer. The consumer is an individual who is a recipient of long-term healthcare or community care services or that individual's family caregiver.

Data categories. Each consumer of long-term healthcare or community care services is associated with a body of information about the consumer's need for services, the nature of services, the cost of services, the process, and outcome of services. This body of information grows over time. This body of information can be broken down into criminal, educational, health insurance, legal, medical, mental health, occupational, substance abuse, and other data categories (or types of information). The eSystem user interface is organized around these data categories. In the user interface page displayed in FIG. 3, there is a button at the left for multiple data categories from “My Home” at the top to “Emergency Procedures” at the bottom. The user clicks on a data category button to open related pages in the user interface. To open the schedule page displayed in FIG. 3, the user has clicked on the “Schedule” button. Only a user with authorized access to the schedule data category sees the schedule button on the left.

Data functions. Each consumer of long-term healthcare or community care services is the associated with a body of information about the consumer's need for services, the nature of services, the cost of services, the process, and outcome of services. This body of information grows over time. This body of information can be broken down into auditing, health insurance transactions, prescription writing, report generation, tracking, scheduling, and other data functions (or operations on information). In the eSystem user interface, data functions are organized within data categories. In the user interface page displayed in FIG. 3, there is an “Add New Record” below the schedule. The user clicks on this button to add an event to the schedule. Only a user with schedule update privileges sees the “Add New Record” button.

Enterprise. An enterprise is an organization such as a clinic, clinical research organization, emergency room, health-maintenance organization, hospital, juvenile court, nursing home, prison, or school system. The enterprise coordinates the efforts of multiple practitioners who provide counseling, detention, educational, emergency response, healthcare, insurance transactions, judicial, law enforcement, medical, mental health, supervision, training, or other services to multiple consumers.

Enterprise account. An enterprise account has all the features of a provider account, plus additional feautures that allow an enterprise organization to manage account authorization within its own organization. Each enterprise account has a designated Security and Privacy Officer (SPO), who is responsible for ensuring that all users within the enterprise organization are properly authorized. If a client account legal agent chooses, they can make an agreement with an enterprise SPO that allows the SPO to authorize enterprise users on the client account.

Enterprise-centric system. In an enterprise-centric system, the enterprise regulates access to consumers' personal information.

Handshake. A handshake is a mechanism by which a client account legal agent and an enterprise account Security and Privacy Officer can agree to share authorization power over a client account. One party offers the handshake to the other. Both parties must agree for authorization sharing to take place. The client account legal agent always retains the ability to sever the agreement.

Multi-discipline. The eSystem has a multi-discipline user interface. When authorized users from different disciplines (e.g., medicine, mental health) logon to the eSystem and enter a client account, they each have selective access to data categories (e.g., medicine, mental health) and data functions (e.g., prescription writing, psychological assessments) consistent with their disciplines.

Multi-level. The eSystem has a multi-level user interface. When authorized users from different levels (e.g., consumer, provider, enterprise representative) logon to the eSystem, each sees a personalized user home page with a selective list of accessible accounts (e.g., consumer's own client account; a client account for each of the provider's patients; a provider account for each enterprise provider). For example, FIG. 4 shows a user home page for a fictional provider, Judy Burge. A “Current Clients” drop-down menu at the center of the page allows Judy to select a client, perhaps Bonnie, and then open Bonnie's client account by clicking the “See Client” button at the right. Provider and enterprise accounts represent superset accounts. The user can click on an accessible account in the list and depending upon access privileges assigned by the client account's legal agent, the user can drill down to specific data categories (e.g., medicine, mental health) and use specific data functions (e.g., prescription writing, psychological assessments, data export, report generation) in one client account. A superset account user can also employ one data function (e.g., report generation) and aggregate across subordinate accounts (e.g., to compile a record of providers' writing of prescriptions for narcotics broken down by clients' gender, ethnicity, age, and health insurance carrier.

Network. A network may be a health or malpractice insurance carrier, a state or federal regulatory agency, a private or public grant-making entity. A network connects multiple enterprises, each coordinating multiple practitioners who provide services to multiple consumers.

Provider. A provider is a practitioner in fields such as education, healthcare, law enforcement, medicine, nursing, psychology, or social work, who offers services to multiple consumers.

Provider account. A provider account allows one or more service providers to aggregate certain functions over multiple client accounts. For example, a provider can run a report on several client accounts from the provider account, rather than running individual reports from each client account.

Relational database. The eSystem relational database includes data tables for each data category and data function. Other tables define matters such as users' authorization privileges and relationships between accounts. An eSystem client account (for Client #1000) includes the rows in each data category and table related to Client 1000. An eSystem superset account (Provider 2545) references the rows in each data category and table related to all subordinate accounts (Provider 2545's authorized client accounts).

Security and Privacy Officer. Enterprise accounts have a Security and Privacy Officer (SPO) who is responsible for the creation, assignment and authorization of accounts within the Enterprise's organization. The system keeps track of which accounts belong to the enterprise account and allows the SPO to exercise authorization power over those accounts. A client account legal agent may choose to allow an enterprise SPO to share authorization power over a client account. This simplifies the authorization process for the client account legal agent and gives the enterprise SPO better control of account access for its workforce.

Superset account. Providers, enterprises, and networks have superset accounts in the eSystem relational database. The named client or legal agent on associated client accounts defines access privileges on superset accounts. Consistent with their privileges, authorized superset account users may selectively access one or more associated client accounts. They may open one or more data categories within selected client accounts (e.g., criminal, educational, health insurance, legal, medical, mental health, occupational, substance abuse). Finally, they may perform a variety of data functions within or across selected data categories (e.g., view, search, update, edit, save, retire, aggregate, restore). In one scenario, access privileges allow a provider's business associates to view and update identified data in the client account (e.g., the social worker's clinical supervisor). In a second scenario, access privileges allow an enterprise's employee (e.g., insurance company medical director) to view and update specified data in the client account (e.g., health insurance transactions related to an August 2002 auto accident). In a third scenario, access privileges allow a network representative (e.g., director of a state child welfare agency) to receive alerts triggered when network enterprises (e.g., social service agencies) and network providers (e.g., case workers) fail to adhere to procedural guidelines (e.g., submit weekly reports on home visits to abused children returned to the home of a previously abusive parent). In general, a superset account user can employ one data function (e.g., search) and aggregate across associated accounts (e.g., to identify doctors broken down by percent compliance with professional practice guidelines for prescription of narcotics to minors).

Superset account user interface. When an authorized user on an eSystem superset account logs on to the eSystem with a valid logon ID and password, the eSystem displays user interface or Web pages consistent with the user's access privileges and preferences. These privileges permit users to view, search, update, edit, save, retire, aggregate, and restore information. For example, FIG. 4 shows a user home page for a fictional provider, Judy Burge who is authorized on multiple client accounts. A “Current Clients” drop-down menu at the center of the page allows Judy to select a client, perhaps Bonnie, and then open Bonnie's client account by clicking the “See Client” button at the right. What Judy can do once she enters Bonnie's account depends upon the data category and data function privileges that Bonnie defined for her.

Objectives. The present eSystem is designed to resolve common dilemmas in the field of long-term healthcare and community care that plague consumers, healthcare providers and enterprises, health and malpractice insurers, and entities that regulate healthcare accreditation and financing. While resolving these dilemmas, the eSystem is designed to surpass the performance of conventional enterprise-centric systems.

Shortcomings of the conventional approach. The conventional approach involves enterprise-centric systems. Enterprise-centric software platforms designed to further the business objectives of private industry have been repackaged and marketed to long-term healthcare and community care providers and enterprises. Enterprise-centric software has evolved to help companies become more profitable than their competitors. Enterprise-centric software is fundamentally incapable of resolving the common dilemmas that cripple the cost-effective delivery of long-term healthcare and community care. In fact, enterprise-centric software perpetuates these common dilemmas. The consumers of long-term healthcare and of community-care deal with vast, uncoordinated, ever-changing array of providers and enterprises that rely on diverse enterprise-centric software. With conventional technology, all the computer-literate providers and enterprises related to one client are using different, unrelated, uncommunicative enterprise-centric systems. Clients' records once resided in many different provider and enterprise filing cabinets, now they reside in many different filing cabinets and on many different provider and enterprise servers. With conventional technology, no one can quickly access all of a client's records in one place, search all these records, or relate one record to one event in the client's history and treatment plans. This is only one example of the insufficiency of conventional technology.

### SUMMARY OF THE INVENTION

The present invention is a client-centric e-health system and method with applications to long-term health and community care consumers, insurers, and regulators (hereinafter “eSystem”). The invention is designed to resolve common dilemmas in long-term healthcare and community care. The invention is also designed to overcome shortcomings of the conventional technological approach to long-term healthcare and community care. To achieve these goals, the invention's unique software engine consists of programming logic that applies business rules to operate the eSystem. For example, the eSystem has business rules that restrict a user's client account access to data categories authorized by the account's legal agent or an authorized enterprise Security and Privacy Officer. When a user logs on and enters an account, the client account user interface displays only data categories for which the user has authorized access. The software engine drives the dynamic flow of information back and forth between client account and superset account user interfaces, the relational database, and client and superset accounts that reference relevant database tables. The software engine allows any number of authorized users to simultaneously access any number of data categories and data functions in client and superset accounts.

### BRIEF DESCRIPTION OF THE DRAWINGS

Other features and advantages of the present invention will become apparent from the following detailed description of the preferred embodiment when read in conjunction with the following drawings of which:

FIG. 1 is a diagrammatic illustration of the system and method of the present invention with respect to one client account;

FIG. 2 is a diagrammatic illustration of the system and method of the present invention with respect to multiple client accounts;

FIG. 3 is a user interface page of one client account as shown on a video monitor;

FIG. 4 is a user interface page for a superset user account as shown on a video monitor;

FIG. 5(a) illustrates conventional enterprise-centric data integration;

FIG. 5(b) illustrates the client-centric multi-level, multi-discipline user integration feature of the present invention;

FIG. 6(a) illustrates how the enterprise centric consumer privacy in a conventional system operates;

FIG. 6(b) illustrates the client-centric consumer privacy feature of the present invention;

FIG. 7(a) illustrates how a conventional enterprise-centric system works for data category integration;

FIG. 7(b) illustrates the client-centric data category integration feature of the present invention;

FIG. 8(a) illustrates how a conventional enterprise-centric system works for time-dependent data integration;

FIG. 8(b) illustrates the client-centric time dependent integration feature of the present invention;

FIG. 9 illustrates the escalating alert feature of the present invention;

FIG. 10 illustrates the document retrieval feature of the present invention;

FIG. 11 illustrates the data permanence feature of the present invention;

FIG. 12 is a schematic diagram of the infrastructure architecture of the system of the present invention;

FIG. 13 (a) illustrates how a conventional enterprise centric system performs health insurance transactions;

FIG. 13(b) illustrates the client—centric health insurance transaction feature of the present invention;

FIG. 14 is a diagrammatic illustration of how authorization sharing of a client account is established between a client account legal agent and an enterprise SPO in accordance with the present invention;

FIG. 15 diagrammatically illustrates how authorization sharing over a client account is limited between a client account legal agent and an enterprise SPO in accordance with the present invention;

FIG. 16 illustrates how the authorization sharing over a client account is between a client account legal agent and an enterprise SPO is terminated in accordance with the present invention;

FIG. 17 shows a patient (client) accessing a user interface in a patient-centric system for entering or revising user privileges in the patient's record in the relational databases;

FIG. 18 shows a patient (client) employing a user interface in the patient-centric system to authorize data-specific directives relative to the privileges currently granted to a user;

FIG. 19 shows a patient employing a user interface in the patient-centric system to monitor user's actions;

FIG. 20 shows the user interface of the patient-centric system for enabling the patient and the patient authorized users to plan, coordinate, monitor, evaluate and improve acute treatment and long term chronic care;

FIG. 20 illustrates how the patient-centric system enables patient authorized users to perform information exchange between conventional enterprise-centric systems and also illustrates the formation of a comprehensive consolidated patient record through the importation to the patient centric system of patient records from multiple conventional enterprise centric systems;

FIG. 21 illustrates how patient authorized information is exchanged in a patient centric system between different enterprise centric systems authorized as users for exchanging information in the patient centric system of the present invention;

FIG. 22 illustrates how a system administrator in a conventional enterprise centric system permits users to access records and view, update and retrieve information etc.;

FIG. 23 illustrates how the patient centric system enforces privileges to authorized users to access records and view, update and retrieve information etc. consistent with the patient consent directives assigned by the patients or designated agents of the patients;

FIG. 24 is a block diagram of the conventional enterprise centric system illustrating how specific functions are enforced; and

FIG. 25 is a block diagram of the patent centric system illustrating how permission is enforced to authorized users relative to the handling of specific functions for specific data in a single patient record consistent with consent directives assigned by the patient to each authorized user in his or her own patient records.

### DESCRIPTION OF A PREFERRED EMBODIMENT

The preferred embodiment of the invention's unique system, methods, and features will become apparent from the detailed description when read in conjunction with the drawings.

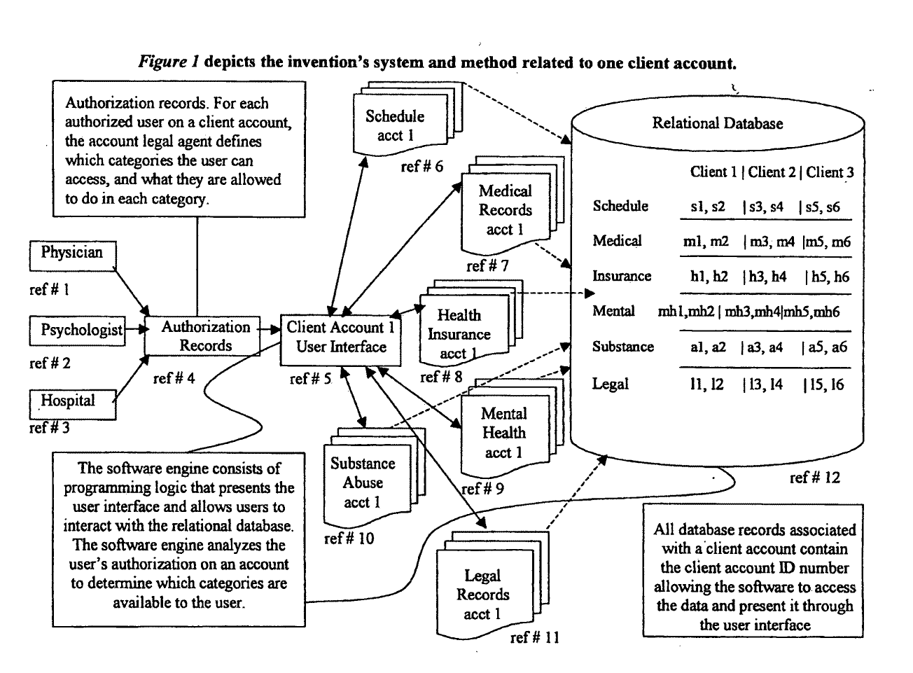

### FIG. 1 Depicts the Invention's System and Method in Respect to One Client Account.

The invention's system consists of a client account user interface (ref# 5), a relational database (ref# 12), and a client account composed of multiple data category records (ref# 6-11). The invention's method uses programming logic to encode client-specified user privileges into authorization records (ref# 4). This logic controls users' (ref# 1-3) exercise of their privileges in the client account via the user interface (ref# 5) on records (ref# 6-11) in the relational database (ref# 12).

For purposes of this example, client account 1 relates to a morbidly obese patient with chronic low-back pain (treated by a neurologist, ref# 1), an eating disorder (treated by a psychologist, ref# 2), and a history of two triple bypass operations (performed by a cardiologist, ref# 3). The three authorized users (ref# 1-3) on client account 1 each logon at 4:30 p.m. on August 5^{th} but from different geographical locations. They do this by entering the system's website address into any device equipped with an Internet browser. Once on the Website, each user enters a logon ID and password in user interface fields requesting this information. The programming logic searches authorization records (ref# 4) in the relational database (ref #12) to determine each user's access privileges and opens a client account user interface (ref #5) that supports client-defined access privileges to data categories and data functions within categories. In this figure, the three authorized users have all privileges (including view, edit, update, retire, restore) on all data categories in the client account (ref #6-11). Each user exercises these privileges via devices in the user interface (ref# 5) such as buttons that when clicked, open data category pages or perform data functions.

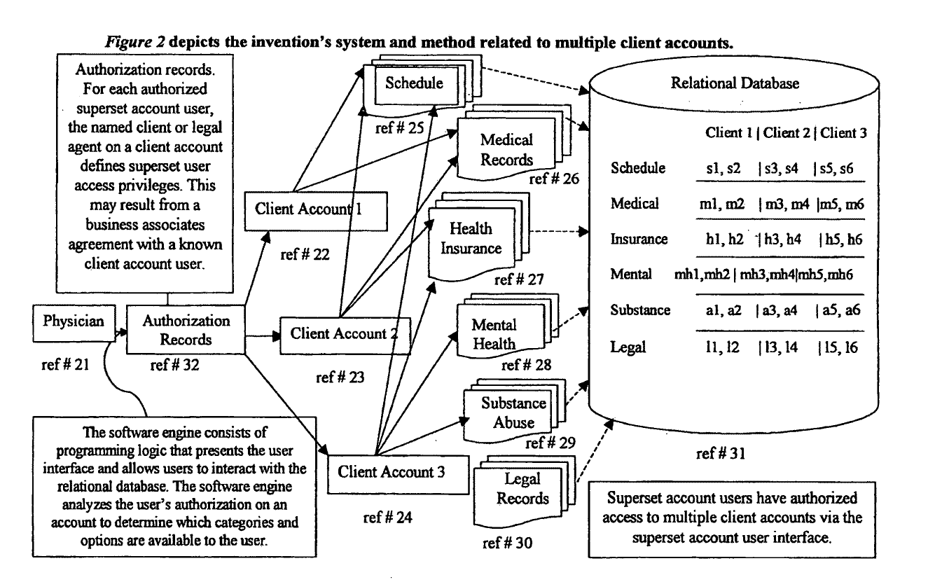

### FIG. 2 Depicts the Invention's System and Method in Respect to Multiple Client Accounts.

FIG. 1 depicted the invention's system in relationship to one client account. FIG. 2 depicts a scenario in which a physician is authorized on multiple client accounts through a superset account user interface (ref# 21) consistent with authorization records (ref# 32) that specify the superset user's specific client-authorized access privileges on multiple client accounts (ref# 22-24) each comprising multiple data category records (ref# 25-30) residing in a relational database (ref# 31). The invention's method uses programming logic to encode client-specified user privileges into authorization records (ref# 32) and to control the user's (ref# 21) exercise of access privileges across multiple client accounts (ref# 22-24) each with records (ref# 25-30) in the relational database (ref# 31).

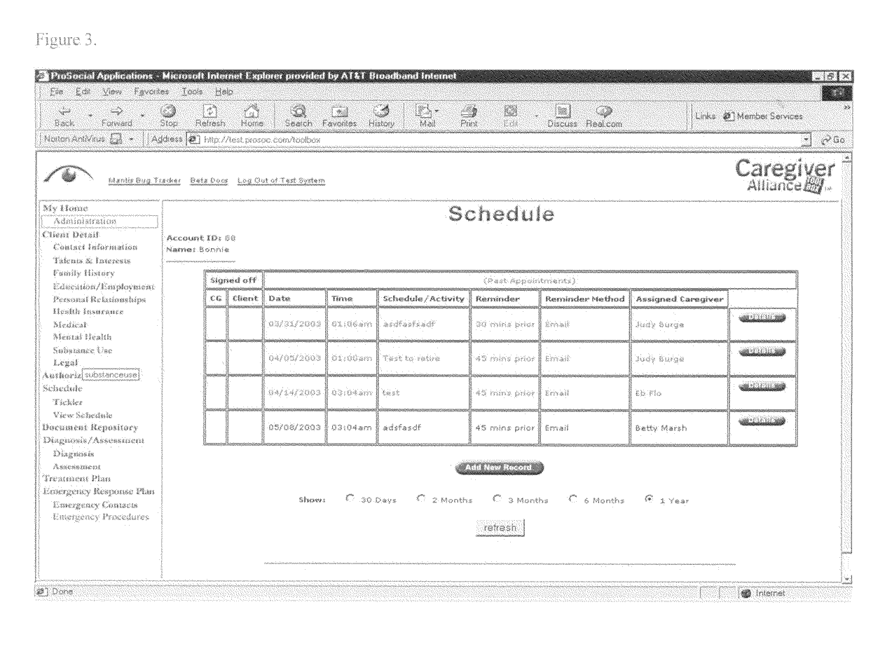

### FIG. 3 is a Screen Shot of One Client Account User Interface Page.

When an authorized user on an eSystem client account logs on to the eSystem with a valid logon ID and password, the eSystem displays user interface or Web pages consistent with the user's access privileges and preferences. The user interface page includes buttons, data-entry fields, and other devices that allow the user to exercise authorized privileges within the account. These privileges permit users to view, search, update, edit, save, retire, aggregate, and restore information. For example, FIG. 3 displays a series of buttons at the left from “My Home” at the top left to “Emergency Procedures” at the bottom left. Each button corresponds to a data category. The user who accessed this page has privileges related to each of these data categories. Users with lesser privileges would see fewer buttons on the left of this interface page. FIG. 3 displays an “Add New Record” button below the schedule. This button corresponds to a data function, adding an event to the schedule. The user who accessed this page has privileges related to this function. Users with lesser privileges might be able to view the schedule page but would not have access to the “Add New Record” button.

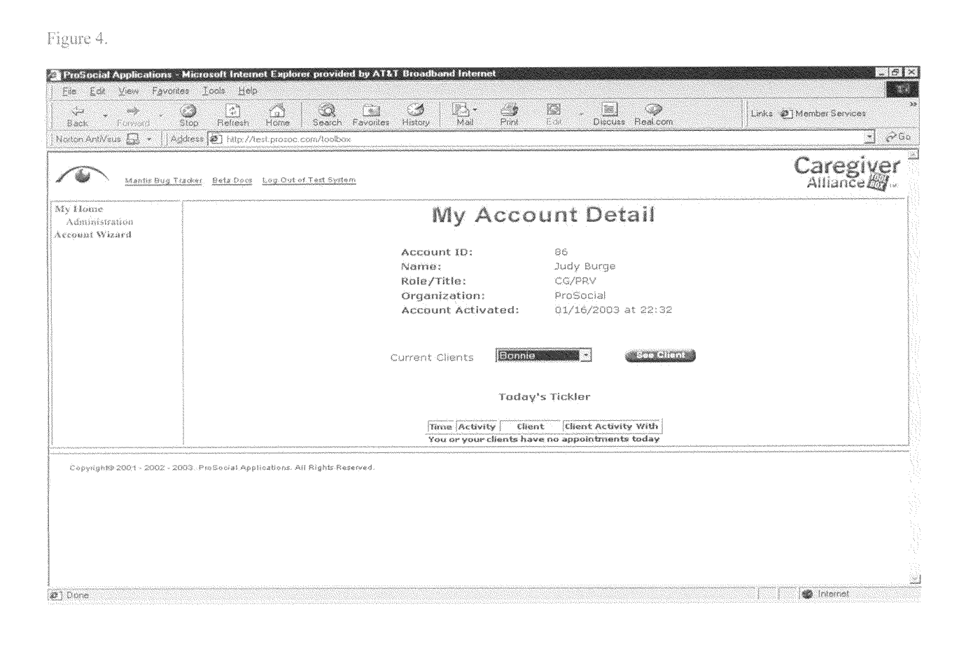

### FIG. 4 is a Screen Shot of One Superset Account User Interface Page.

When an authorized user on an eSystem superset account logs on to the eSystem with a valid logon ID and password, the eSystem displays user interface or Web pages consistent with the user's access privileges and preferences. These privileges permit users to view, search, update, edit, save, retire, aggregate, and restore information. For example, FIG. 4 shows a user home page for a fictional provider, Judy Burge who is authorized on multiple client accounts. A “Current Clients” drop-down menu at the center of the page allows Judy to select a client, perhaps Bonnie, and then open Bonnie's client account by clicking the “See Client” button at the right. What Judy can do once she enters Bonnie's account depends upon the data category and data function privileges that Bonnie defined for her.

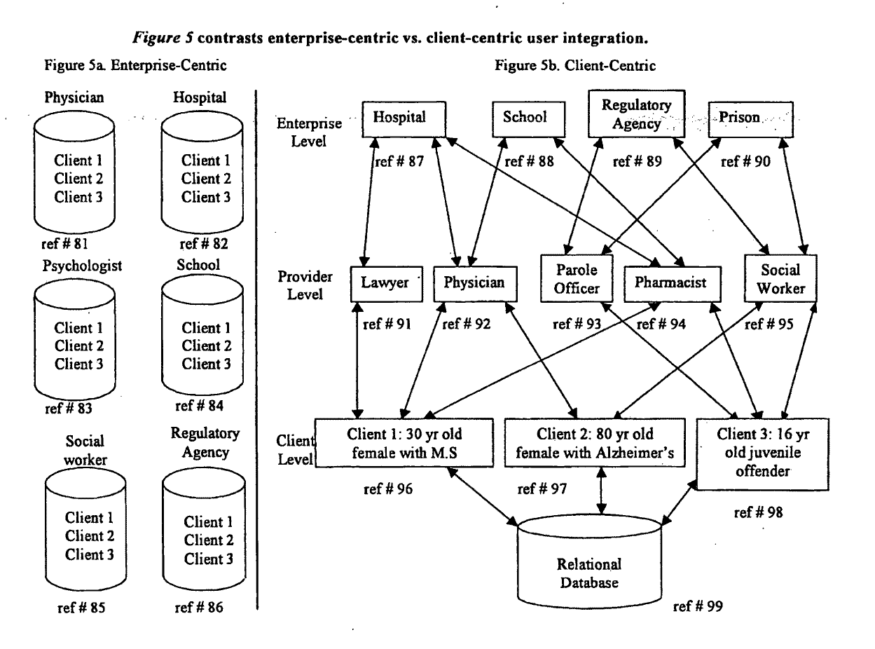

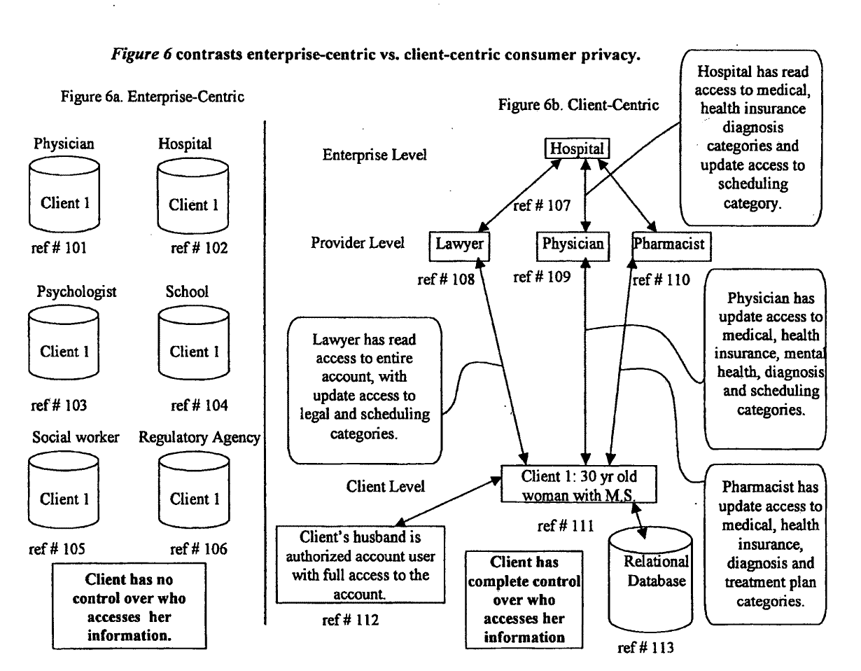

FIG. 5 Contrasts Enterprise-Centric (FIG. 5a) Vs. Client-Centric (FIG. 5b) User Integration.
FIG. 5a illustrates conventional enterprise-centric data integration. Three providers (ref #81, 83, 85) and three enterprises (ref #82, 84, 86) each have their own enterprise-centric database (ref #81-86). The lack of connection between enterprise-centric databases (ref #81-86) precludes information sharing or coordination among providers and enterprises providing overlapping services to Clients 1, 2, and 3.
FIG. 5b illustrates the invention's unique client-centric multi-level, multi-discipline user integration feature, an expression of the invention's unique system and methods. FIG. 5b shows user integration across user levels (client, provider, enterprise) and across user disciplines (medicine, psychology, education, social work, regulatory compliance). FIG. 5b shows integrated information sharing and activity coordination among five providers (ref# 91-95) and four enterprises (ref# 87-90) providing overlapping services to three clients (ref# 96-98). One relational database (ref# 99), stores information in each client account so that it is accessible to a multi-level (provider, enterprise), multi-disciplinary (lawyer, physician), ever-changing array of authorized account users.
   FIG. 6 Contrasts Enterprise-Centric (FIG. 6a) Vs. Client-Centric (FIG. 6b) Consumer Privacy.

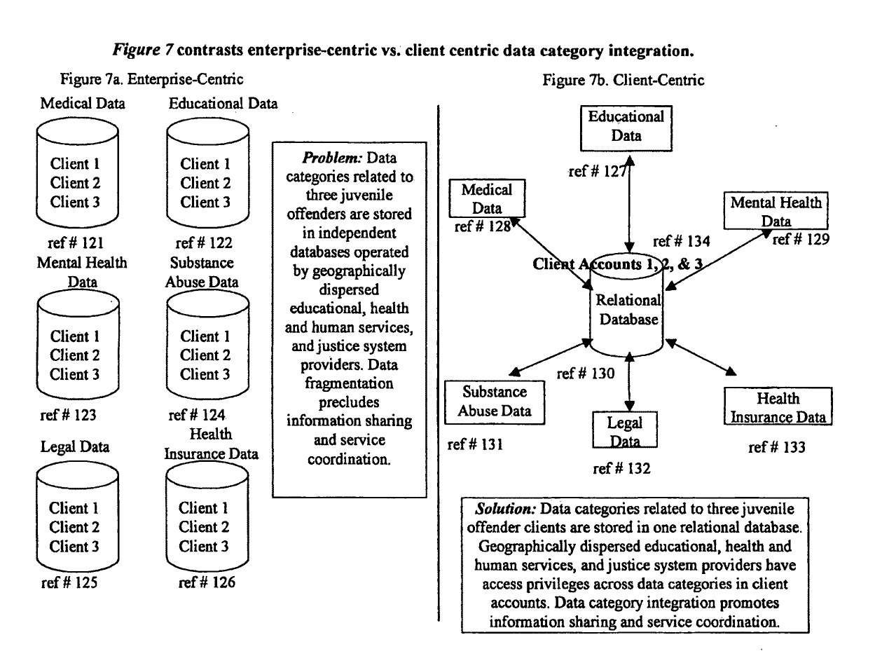

In this example, Client 1 is a 30-year-old woman with multiple sclerosis cared for by her husband.
FIG. 6a shows conventional enterprise-centric consumer privacy involving six independent enterprise-centric databases (ref# 101-106), each of which includes fragments of Client 1 healthcare information. The consumer (and her husband) do not know what personal information is in these databases. They exercise no control over users who access personal information in these databases. They do not know and cannot control users who view, update, or delete information in her records in any of these databases.
FIG. 6b illustrates the invention's unique client-centric consumer privacy feature, an expression of the invention's unique system and methods. FIG. 6b shows one client-centric relational database (ref# 113). In the database is Client 1's client account (ref# 111) composed of all data categories of Client 1's healthcare information. Authorized enterprise (ref# 107), provider (ref# 108-110), and family caregiver (ref# 112) users differ in their access privileges to the client account. The client has complete control over user access to her client account. She decides who is an authorized user, what data categories they see in the user interface, what data functions they employ within a data category. She can change these designations at any time through administration functions in the client user interface.
   FIG. 7 Contrasts Enterprise-Centric Vs. Client-Centric Data Category Integration.

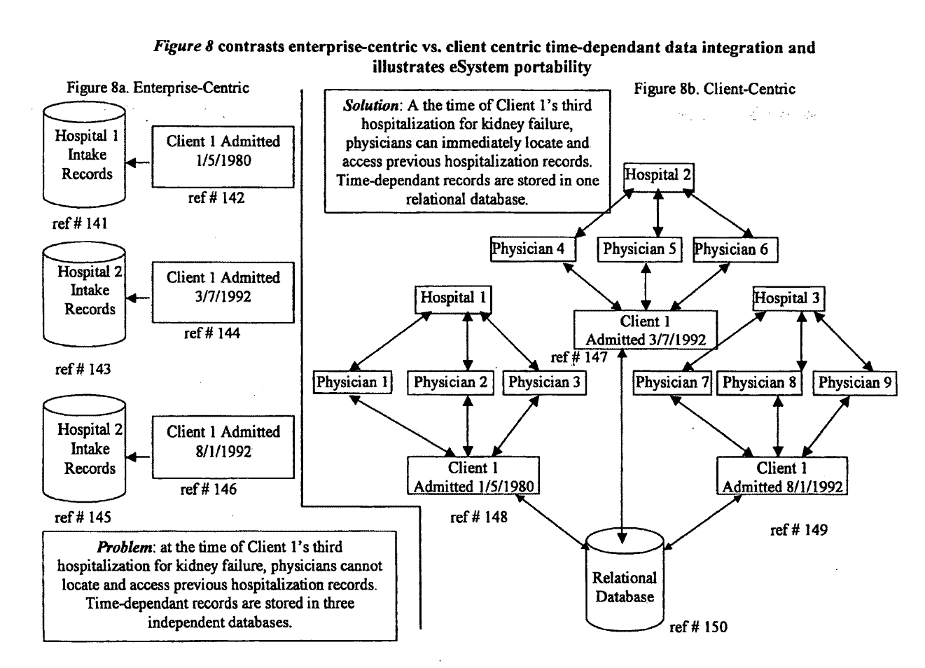

In this example, Clients 1, 2, and 3 are juvenile offenders on probation in the community. Each client receives services from geographically dispersed educational, health and human services, and justice system providers.
FIG. 7a shows conventional enterprise-centric data category integration involving six independent enterprise-centric databases (ref# 121-126). Each database is dedicated to a particular data category (e.g., legal data, medical data) and maintained by a provider (e.g., probation officer, doctor). Fragmented databases prevent geographically dispersed and organizationally unrelated providers from sharing information and coordinating service delivery.
FIG. 7b illustrates the invention's unique client-centric data category integration feature, an expression of the invention's unique system and methods. FIG. 7b shows one client-centric relational database (ref# 130) including three client accounts (ref# 134). Each client account comprises six data categories (ref# 127-132) to which all authorized users have access. Data category integration promotes sharing of information and coordination of service delivery among geographically dispersed and organizationally unrelated providers.
   FIG. 8 Shows the Invention's Portability and Contrasts Enterprise-Centric Vs. Client-Centric Time-Dependent Data Integration.

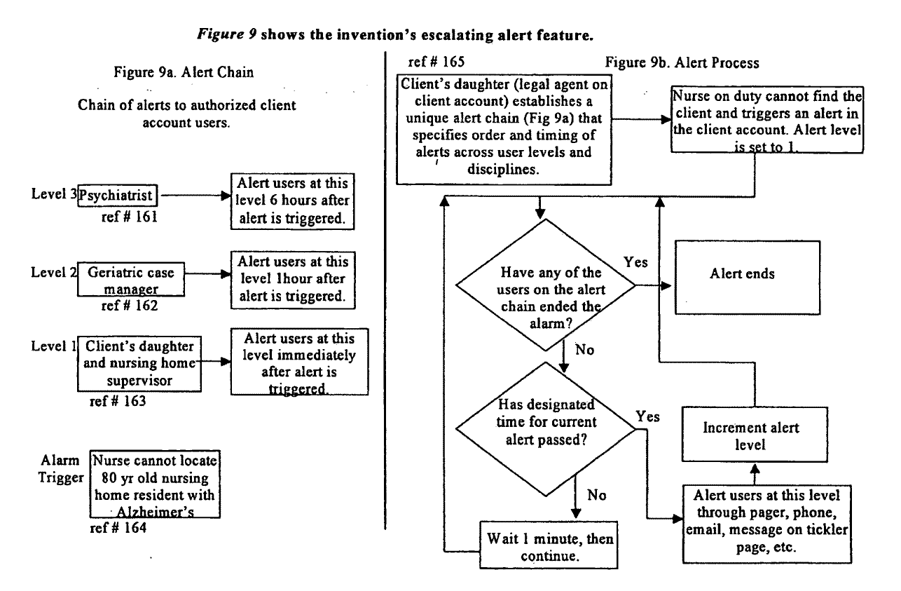

In this example, Client 1 has been admitted at three different times to three different hospitals for kidney failure.
FIG. 8a shows conventional enterprise-centric time-dependent data integration. FIG. 8a shows three independent enterprise-centric databases (ref# 141, 143, 145) each operated by a hospital in California, Michigan, or Florida. In each database are records from admissions of Client 1 during kidney failure (ref #142, 144, 146) at a different time. Client 1 is unconscious when he is admitted for his third hospitalization (ref# 142). Physicians at Hospital 3 who examine and treat Client 1 have no way to locate or access previous time-dependent hospitalization records (ref# 142, 144) that are of critical importance to Client 1's recovery.
FIG. 8b illustrates the invention's unique client-centric time-dependent data integration feature, an expression of the invention's unique system and methods. FIG. 8b shows one relational database (ref# 150) integrating time-dependent records from three hospitals in California, Michigan, and Florida related to admission of Client 1 during kidney failure (ref #148, 147, 149). Client 1 is unconscious when he is admitted for his third hospitalization (ref# 149). Physicians 7, 8, and 9 who examine and treat Client 1 during his third admission (ref# 149) can immediately locate and access previous time-dependent hospitalization records (ref# 147, 148) that are of critical importance to Client 1's recovery.
FIG. 8b also illustrates the invention's portability feature, an expression of the invention's unique system and methods. As a consumer changes doctor's and hospitals, he can remove authorization from some account users and establish authorization for other account users. All this is accomplished without any loss of information in the client account.
   FIG. 9 shows the invention's escalating alert feature.

In this example, the client is an 80-year-old Alzheimer's patient and nursing home resident.
FIG. 9 illustrates the invention's unique escalating alert feature, an expression of the invention's unique system and methods. The escalating alert feature is possible only in a client-centric system that integrates users across levels and disciplines as depicted in FIG. 5.
This example shows how the alert chain works. As FIG. 9 shows, the alert chain (FIG. 9a) is triggered (ref# 164) when a nurse cannot locate an 80-year-old Alzheimer's resident of a nursing home. The client's daughter (legal agent on client account, ref #165) establishes a unique alert chain for her father's client account that is deployed via standard alert process shown in FIG. 9b. The alert chain in FIG. 9a specifies the unique order and timing of alerts issued via a standard alert process (FIG. 9b) across user levels (e.g., client's daughter, geriatric case manager, nursing-home supervisor) and disciplines (e.g., psychiatry, geriatric case management) (ref#161-164). The escalating alert feature is possible only in a client-centric system that integrates users across levels and disciplines as depicted in FIG. 5.

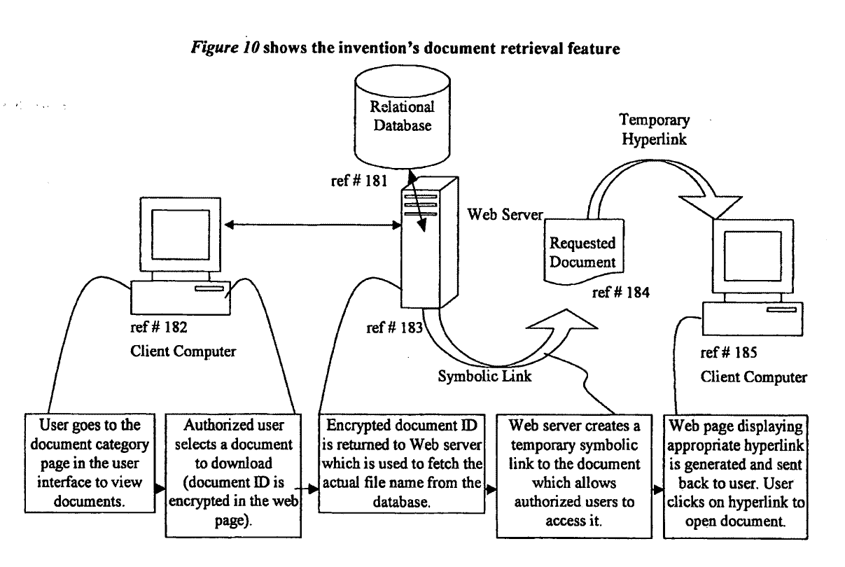

### FIG. 10 Shows the Invention's Document Retrieval Feature.

FIG. 10 illustrates the invention's unique document retrieval feature, an expression of the invention's unique system and methods. The document retrieval feature is possible only in a client-centric system that establishes unique authorization privilege records to each data category in a client account for each account user as depicted in FIG. 1 and that protects consumer privacy as depicted in FIG. 6.
This example illustrates how the document retrieval feature works. An authorized account user in Boston (the client) stores his original documents (e.g., x-rays, living wills, and psychiatric evaluations) in relevant data categories within his client account (e.g., medical, legal, mental health). Later, another user in Detroit (the client's lawyer) uses his computer (ref# 182) to access the relevant document category page in the user interface and select a document (e.g., living will) to download. The encrypted document ID for the selected document is returned to the invention's Web server (ref# 183), which is used to fetch the actual file name from the relational database (ref# 181). The Web server (ref# 183) creates a temporary symbolic link to the requested document (ref# 184). The Web page displaying the appropriate hyperlink is generated and sent back to the user so that the client's lawyer in Detroit can access the requested document via his computer (ref# 185).

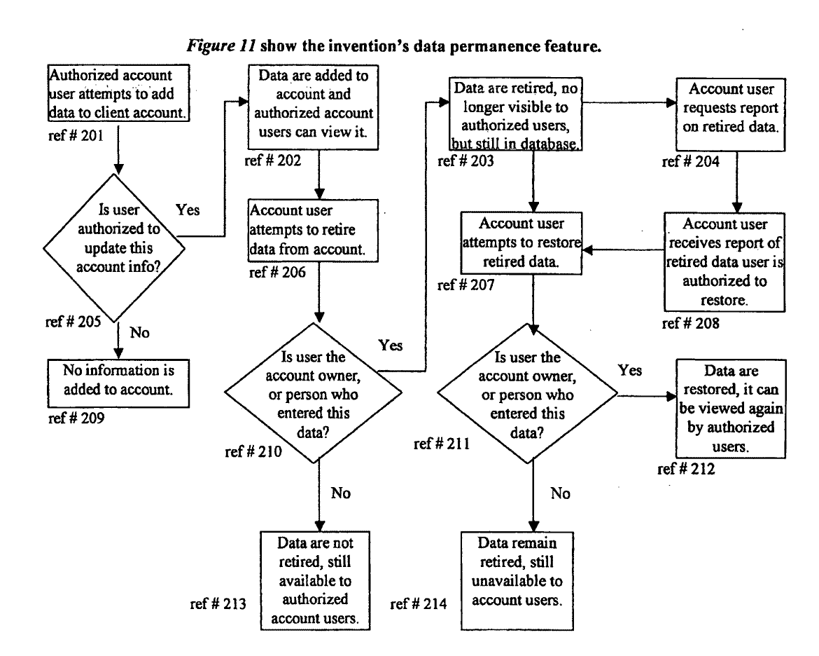

### FIG. 11 Shows the Invention's Data Permanence Feature.

FIG. 11 illustrates the invention's unique data permanence feature, an expression of the invention's unique system and methods. The data permanence feature is essential for operation of a client-centric system that integrates information relevant to one client across data categories (FIG. 7), across users (FIG. 5), and across time (FIG. 8). With data permanence, the client account becomes an unquestionably objective and reliable repository of information about the sequence of activities of one or more authorized users and a solid foundation for the audit trail feature described in Example 1. Without data permanence, a nurse involved in a fatal medical mistake could delete pertinent information.
This is how the data permanence feature works. The eSystem's relational database includes business rules, shown in FIG. 11, to determine changes that can be made in client account information. The eSystem's programming logic checks the user's authorization record and presents a client account user interface consistent with user access privileges. In brief, here are the business rules related to data permanence. A user must be authorized to add information in a specified data category (ref# 205). Only the client account legal agent or person who entered data may retire data from the account to an archive (data are never deleted, can always be restored from archive, some data can never be retired) (ref# 213). Only the client account legal agent or person who entered data can restore the data to view (ref# 211). Whenever data is retired or restored, the client account legal agent is notified via a system message. Thus, no user can retire or restore data without the knowledge of the legal agent.

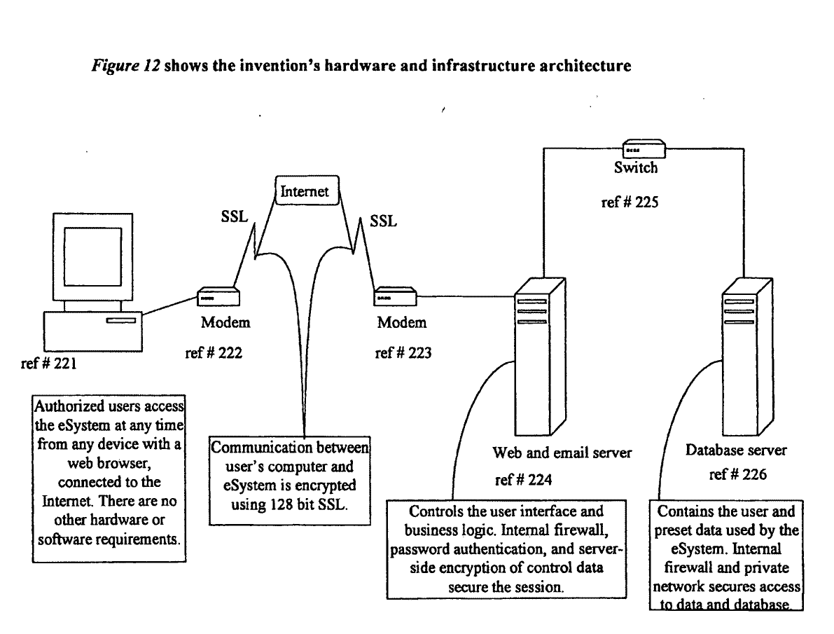

### FIG. 12 Shows the Invention's Hardware and Infrastructure Architecture

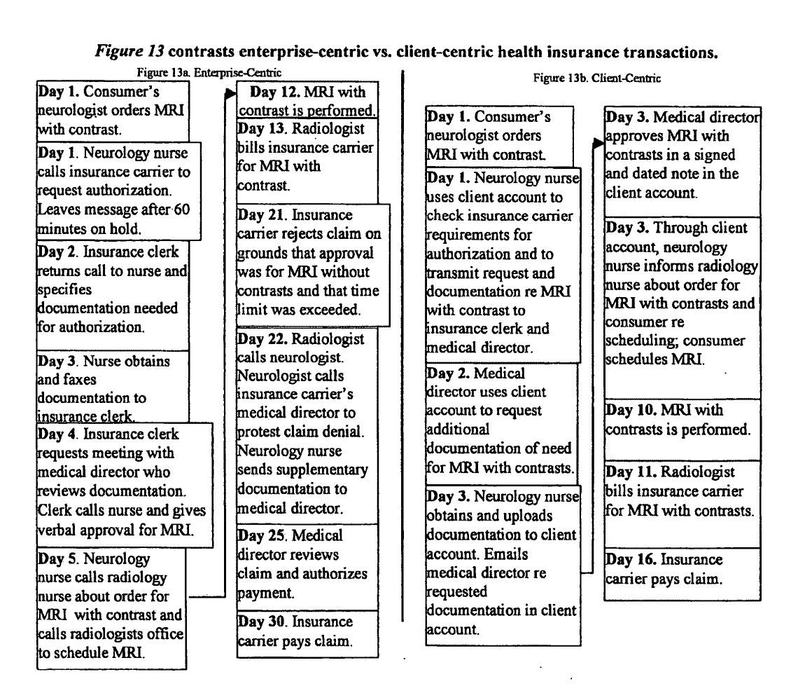

comprising the user's Internet browser, modem equipped device (ref# 221), programming that encrypts communication between the user's device and the eSystem (ref# 222, 223), a Web and email server that controls the user interface and business logic (ref# 224), a switch (ref# 225) that connects to the database server (ref# 226). The switch is a standard piece of network hardware that facilitates communication between application and database servers.
   FIG. 13 Contrasts Enterprise-Centric Vs. Client-Centric Health Insurance Transactions.
FIG. 13a illustrates conventional enterprise-centric health insurance transaction. With or without the support of an enterprise-centric medical records system, enterprise-centric health insurance transactions take longer, cost more money, and are fraught with more errors than the client-centric method. Most of the people involved in health insurance transactions, including clients and family caregivers, have no access to the enterprise-centric record system. The information needed for cost-effective health-insurance transactions is fragmented across record-keeping systems specific to data categories (FIG. 7), user levels and disciplines (FIG. 5), and time (FIG. 8).
FIG. 13b illustrates the invention's unique client-centric health insurance transaction feature, an expression of the invention's unique system and methods. Cost-effective health insurance transactions are possible only in a client-centric system that integrates all of a client's healthcare information in one relational database across data categories (FIG. 7), users (FIG. 5), and time.
This is how the client-centric health insurance transaction works as illustrated in FIG. 13. A claims clerk at the health insurance carrier and the medical director are established as authorized users on the health insurance category of a customer's client account (and on no other data category). Following an electronic handshake between the client and the insurance carrier, the health insurance category of the client account receives an additional page branded with the company name “Safety Net Inc.” From this page, all authorized client account users can access the client's policy, the company's requirements for procedure certification, and Web page claims forms. Client and healthcare providers can fill in these Web page forms while in the client account, and submit them directly to the insurance company's payment agents and medical directors through their superuser account. Copies of the submission remain in the client account. All relevant parties are notified on their message boards about the submission. All transactions are tagged with the user ID. Given this permanent electronic identification, in documents and in audit trails, there is no need to download, sign, notarize, and upload documents for transmission. Documents involved in transactions are sent in permanent, read only, form. The insurance company rep can transmit information about claims into the account with automatic notification of all relevant account users and others with need to know who are not account users. Through the client account, the insurance carrier's medical director can request and receive documentation from account users such as the doctor's progress notes, requests for procedures, and accompanying documentation and test results. Through the client account, the insurance carrier can definitively inform account users about parameters of certification of requested procedures.

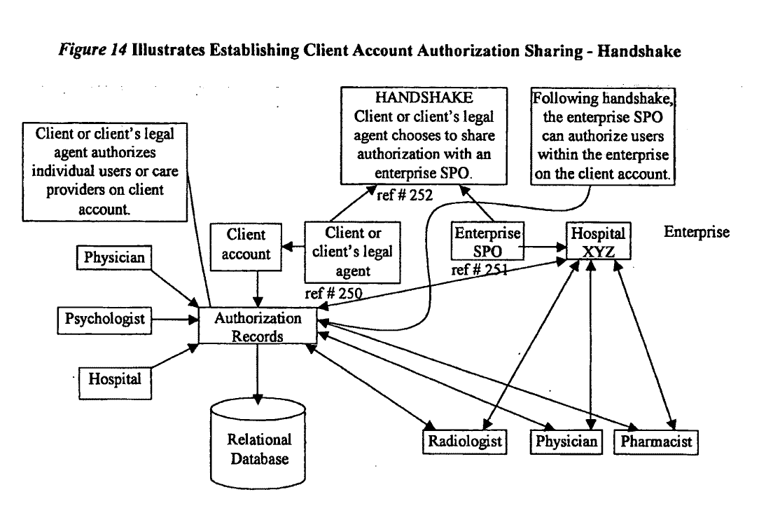

### FIG. 14 Shows the Invention's Coordinated Assessment and Referral Feature.

FIG. 14 illustrates the invention's unique coordinated assessment and referral feature, an expression of the invention's unique system and methods. Rapid, safe, and cost-effective assessment and referral of consumers requiring complex community care is possible only in a client-centric system that integrates all of a client's community care information in one relational database across data categories (FIG. 7), users (FIG. 5), and time.

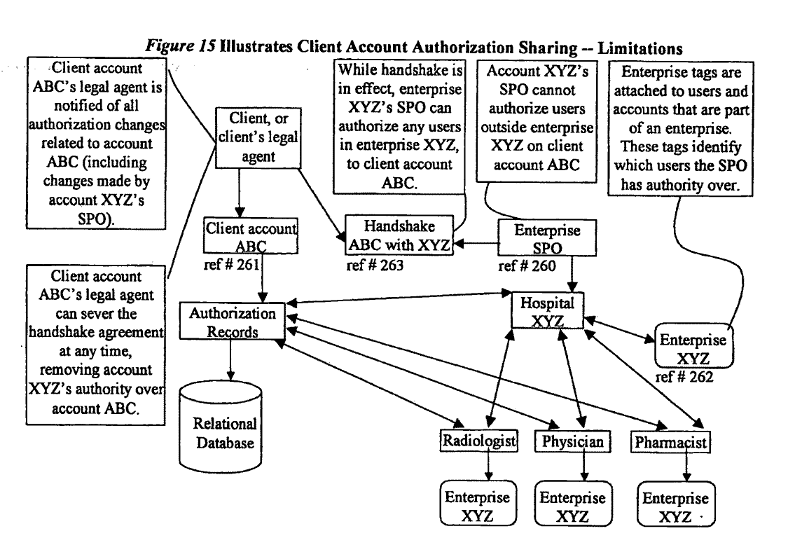

### FIG. 15 Shows the Invention's Coordinated Case Management Feature.

FIG. 15 illustrates the invention's unique coordinated case management feature, an expression of the invention's unique system and methods. Cost-effective case Management consistent with empirically validated standards of community care is possible only in a client-centric system that integrates all of a client's community care information in one relational database across data categories (FIG. 7), users (FIG. 5), and time.

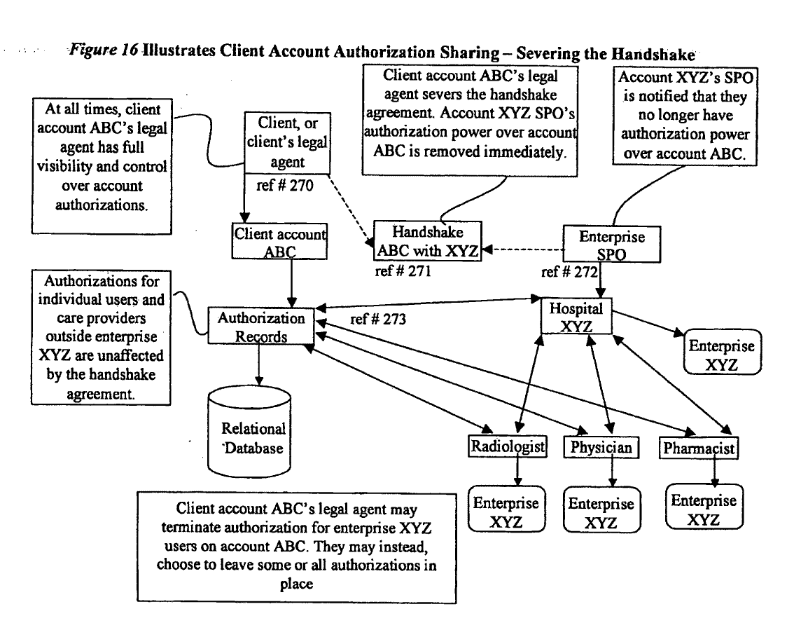

### FIG. 16 Shows how the Invention Allows Authorization Sharing Over a Client Account Through a Handshake Agreement Between a Client Account Legal Agent and an Enterprise SPO.

The client account legal agent (ref# 250) always retains ultimate authorization power over a client account. But, if they choose, they may grant limited authorization power to an enterprise Security and Privacy Officer (SPO) (ref# 251). This power is granted through a handshake agreement (ref# 252) between these users. While the agreement is in place, the enterprise SPO can authorize users, from within their enterprise, on the client account.

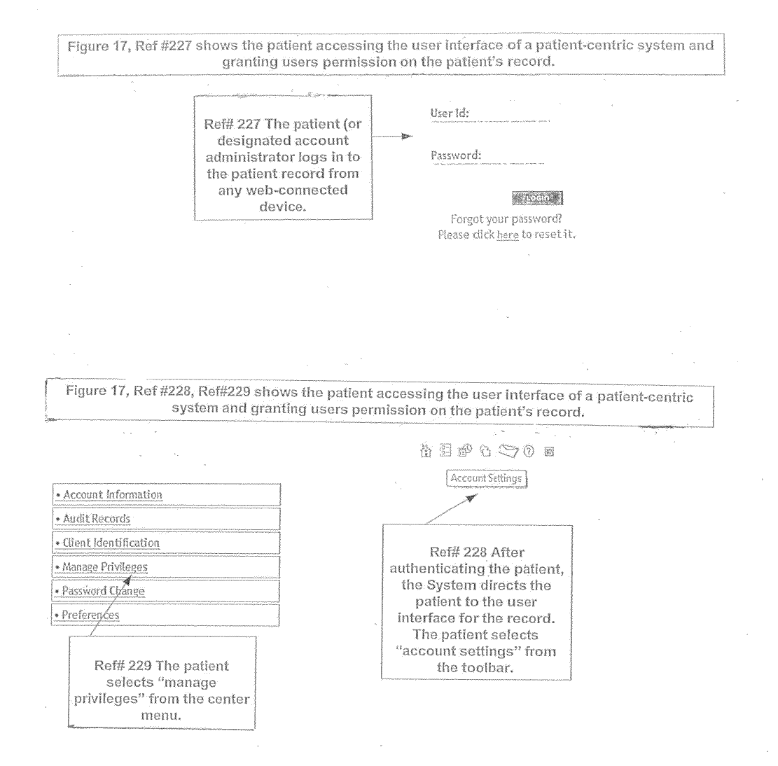

### FIG. 17 Shows how the Invention Limits Authorization Sharing Over a Client Account Through a Handshake Agreement Between a Client Account Legal Agent and an Enterprise SPO.

When an enterprise SPO (ref# 260) is granted authorization power over a client acount (ref# 261), this power is limited to the users and accounts that are designated as part of their enterprise. The system maintains tags (ref# 262) on these users and accounts so that it can recognize which users and accounts an enterprise SPO is allowed to act on. An enterprise SPO is unable to authorize a user outside their enterprise, on a client account.
While the handshake agreement (ref# 263) is in effect, both the client account legal agent and the enterprise SPO, share authorization power over authorizations between the enterprise and the client account. Either of these individuals can add, change or delete authorization records between these entities. The system notifies the client account legal agent of all authorization changes affecting the client account (including those made by an enterprise SPO). The client account legal agent always retains the ability to cancel a handshake agreement with an enterprise SPO.

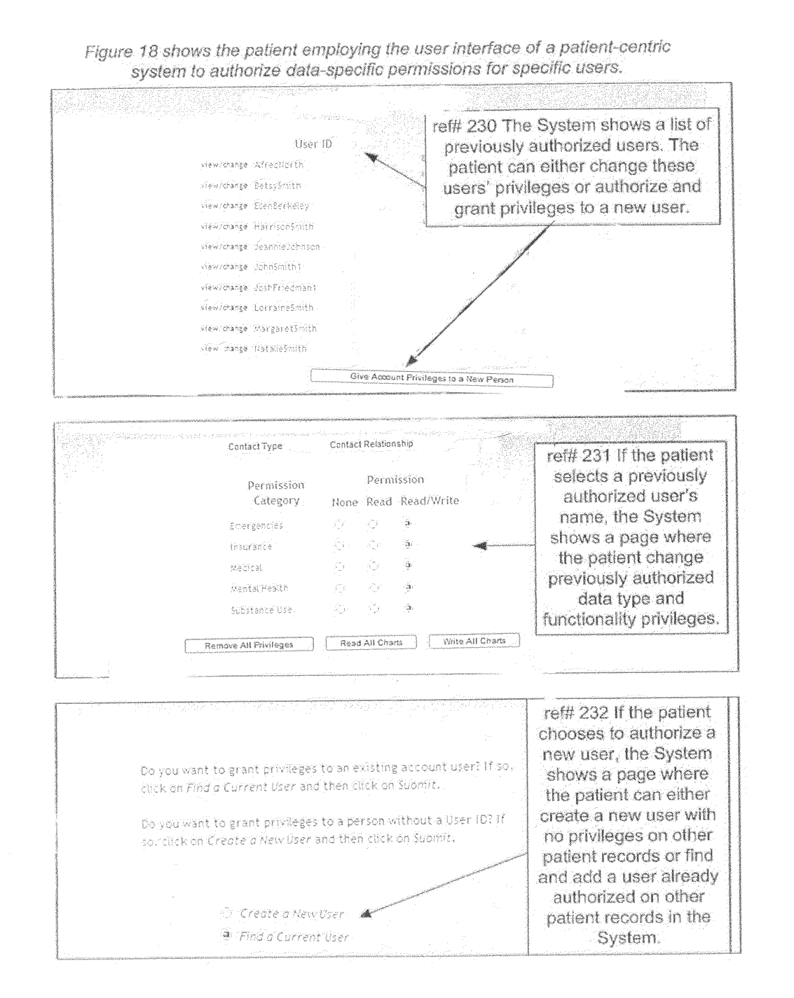

### FIG. 18 Shows how the Invention Allows a Client Account Legal Agent to Sever a Handshake Agreement, Removing an Enterprise Spo's Authorization Power Over the Client Account.

For any reason, the client account legal agent (ref# 270) may sever a handshake agreement (ref# 271) with an enterprise SPO (ref# 272). The legal agent severs the handshake agreement through the client account user interface. The interface provides a view of all handshake agreements that are in place, and has options for the legal agent to end these agreements. When this occurs, the enterprise SPO's authorization power over the client account is immediately removed. The SPO is notified of this change in authorization power.
After severing the handshake, the client account legal agent retains authorization power over the authorizations (ref# 273) established by the enterprise SPO. They can make any changes to those authorizations that they wish, including terminating any or all of them.

### Example 1 Shows the Invention's Client-Centric Audit Trails Feature

Example 1 illustrates the invention's unique audit trails feature, an expression of the invention's unique system and methods. Enterprise-centric systems have audit trails, but they document only the activities of enterprise users, not the activities of consumers and family caregivers as well as other account users involved in client care but not associated with the enterprise. As such, enterprise-centric systems do little to protect healthcare providers against malpractice claims. The client-centric audit trail documents in chronological sequences the activities of clients, family caregivers, and all the authorized provider and enterprise account users who are involved in consumer care.
The client-centric audit trail is made possible by an eSystem that integrates users (FIG. 5), integrates data categories (FIG. 7), integrates time-dependent data (FIG. 8), and protects data permanence (FIG. 11).
This is how the client-centric audit trail feature works. An audit trail automatically documents each step an authorized user makes in one client account or across client accounts through a superuser account. Audited information includes user ID, dates and times of account access, dates and times of access to data categories in the account; dates and times of access to functions and documents within data categories. All audited information is permanent and cannot be deleted, edited, or retired for archiving by any account user including the named client or legal agent. In fact, only a representation of audited information is available through reports generated via client or superset accounts. An audit trail report shows only data category information consistent with a user's access privileges on an account. Users generate audit trail reports by clicking a “Reports” button on the left navigation bar of the Client or Superuser Account Home Page, and then an “Audit Trail” button. A generic reports specification page opens, requesting search parameters including date range, account users, and data categories. The requested audit trail report appears on the user's screen. Even after a user's access to a client account is terminated, the user can generate an audit trail for the period of authorization consistent with then prevailing access privileges.
Example 1 illustrates how the client-centric audit trail feature works. In the case summary (left column, top paragraph), a primary care doctor may be liable for a patient's adverse reactions to medication the doctor prescribed. The doctor asked the right questions prior to prescribing, but got misleading information from the patient's daughter, that she later denied when initiating a malpractice claim. Example 1, left column, bottom paragraph describes how a doctor can use the client account to prevent liability. Example 1, right column, top paragraph describes how a doctor can use the audit trail to prove a reasonable standard of care and minimize liability. A snapshot of a relevant audit trail report is presented in Example 1, right column, bottom paragraphs.

A principal characteristic of the client centric system of the present invention resides in the retention of control by each client or the designated agent of such client over user access and user privileges to the records corresponding to the respective client in the database as opposed to an enterprise centric system in which all control over user access and user privileges to all records of all clients in the database rests in the hands of a single system administrator and to the appointees of the system administrator. This feature is fundamental to the client centric system and underlies the methodology of the invention shown in each of FIGS. 1-8 of the originally filed U.S. patent application Ser. No. 10/210,127 filed on Aug. 1, 2002 and in U.S. patent application Ser. No. 10/431,845 filed on May 8, 2003 as a continuation-in-part of U.S. patent application Ser. No. 10/210,127. By allowing the client to retain complete and total control over user access to her (or his) records in the database only the client or the designated representative of such client can make changes to user privileges including adding privileges, removing privileges, adding users and/or deleting users at will.

The word “client” is used in the subject invention in the generic sense to mean any individual record holder in the database. However, since the client represents a patient with regard to the record holder's medical, substance abuse, and mental health data records, the term “client” and “patient” become synonymous with regard to such records. Accordingly, for purposes of simplicity the system of the present invention will hereafter be referred to as a “patient centric system,” since the clients' records will invariably include medical records and data relative thereto. Thus, in the patient centric system of the present invention, it is the patient or the designated representative of such patient that controls the privileges granted to an individual human user, or to a user's computer system, when accessing the records of such patient. The privileges granted to a user represent consent directives generated by the patient or legal agent thereof and serve to distinguish different privileges and functions which a patient may grant to different users, and to their computer systems, including but not limited to selective data viewing, updating, entry, consolidation, archiving, meta-tagging and the importing and exporting of data into and out from the records of such patient in the relational database(s). In contrast, in a conventional enterprise centric system, the system administrator acts alone or through authorized appointees of the system administrator to determine who shall access the records in the database of any patient and controls all privileges, for all data types, and for all functions granted to a user in each patient (client) record in the database even to the exclusion of the patient (client).

The designated representative of a patient functions as the legal agent of the patient in the patient centric system and, as such, the patient or legal agent thereof can review the list of currently assigned users to access the records of such patient and can change user privileges in real time i.e., whenever the patient or legal agent thereof chooses to do so. The designated representative of the patient may be a family member who for purposes of the present invention represents the legal agent of the patient. The patient or legal agent thereof will function as the “account administrator” for such patient when accessing the patient's record in the relational database(s) in the system through a user interface. When the patient or legal agent thereof logs into the patent centric system and is authenticated only such patient or legal agent thereof has the authority in real time to continuously monitor, revise or modify as well as to withdraw access privileges previously assigned or granted to an authorized user. In addition the patient or legal agent may impose new limitations upon a previously authorized user or delete authorization.

A user is granted privileges by each patient or legal agent thereof in what is referred to as “authorization records” in the patient centric system. Authorization records list the users and identify the privileges granted by the patient or legal agent thereof in respect to specific patient records, data types, and functions. This is preferably accomplished in the patient centric system of the present invention as illustrated in FIG. 16 which consists of three parts labeled ref# 227, ref# 228 and ref# 229 respectively. It is understood that authentication involves requesting unique identifiers from the user during login and matching the user's entry of unique identifiers with identifiers stored in the patient-centric system's database records.

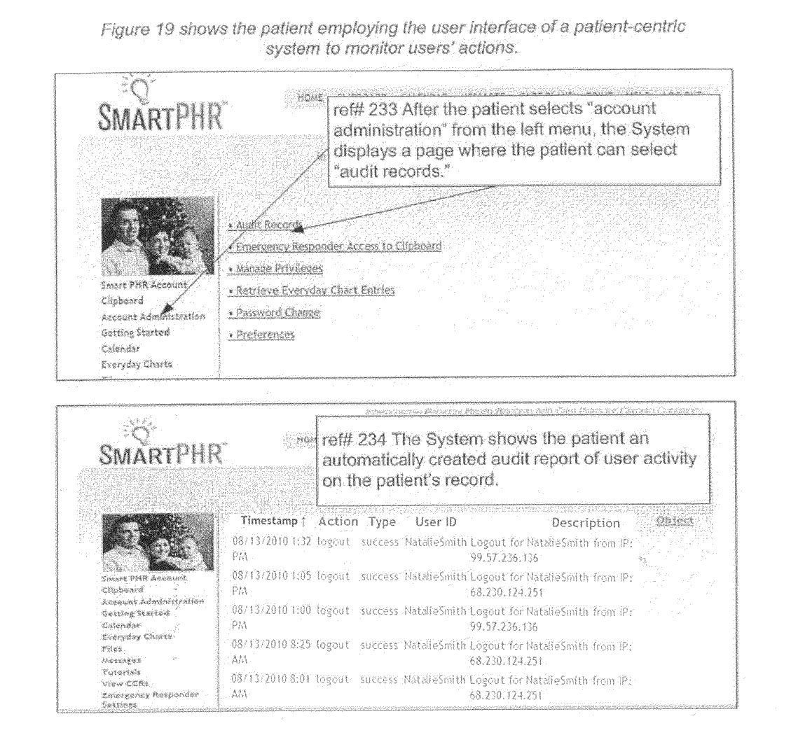

The programming logic in the patient centric system displays user interface pages, enabling the patient or legal agent thereof to grant users permission on the patient's record. In FIG. 17 ref# 227 the patient or legal agent logs into the system from any web connected computer device from which data may be transmitted and received including a web connected mobile phone. In FIG. 17 ref# 228 the patient or legal agent selects “account administration” from the toolbar. In FIG. 16 ref# 229 the patient or legal agent selects “manage privileges” from the center menu. FIG. 18, which also consists of three parts labeled ref# 230, ref# 231 and ref# 232 respectively, illustrates how the patient or legal agent controls privileges to authorized users and their computer systems. In FIG. 18 ref# 230 the patient locates the list of users which he or she previously authorized to access his or her account. A plurality of fictitious names are listed for illustrative purposes as examples of authorized users having previously been granted privileges. FIG. 18 ref# 231 shows that the patient or legal agent can change the privileges of previously authorized users. FIG. 18 ref# 232 shows that the patient or legal agent finds and authorizes a user who already has privileges on other patient records in the system or creates a new user who has no privileges on other system records. FIG. 19 shows that the patient or legal agent monitors user actions. FIG. 19 consists of ref# 233 and ref# 234 respectively. To view automatically collected audit records, the user selects the link to audit records as is shown in FIG. 19 ref# 233. FIG. 19 ref# 234 displays up to date audit records of user activity following the selection of audit records.

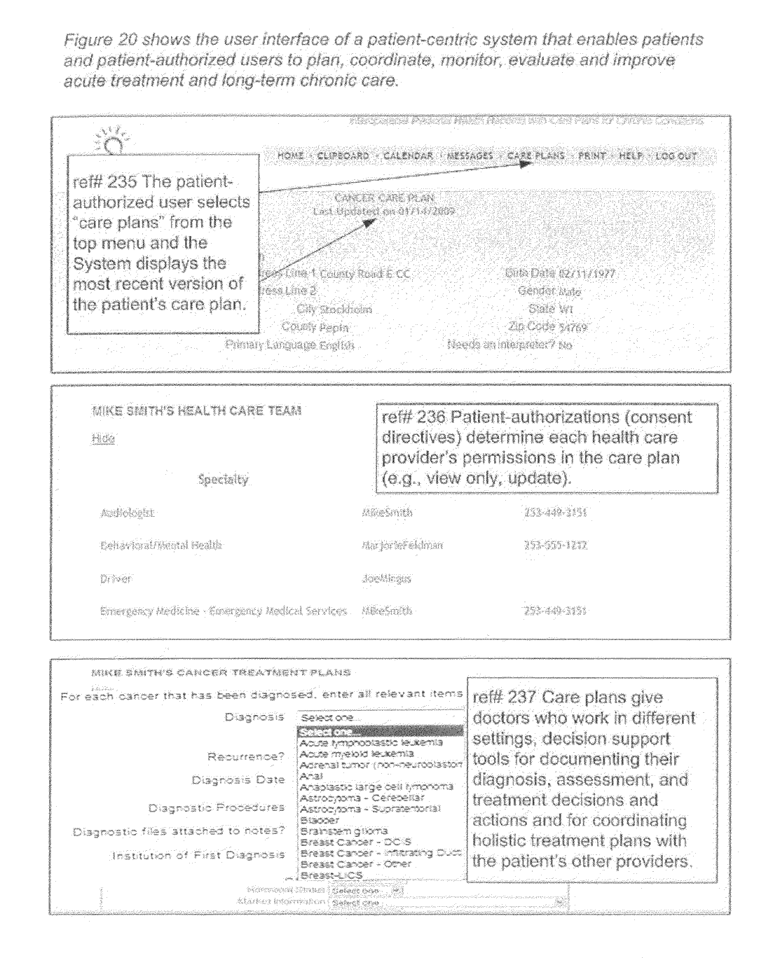

FIG. 20 which consists of ref# 235, ref# 236 and ref# 237 shows that a patient and patient authorized users employ the user interface to plan, coordinate, monitor, evaluate and improve treatment. In ref# 235 the user selects “care plans”. Ref# 236 identifies a care team for a care plan and ref# 237 the type of care plan. Each selected care plan will permit patient-authorized users, such as doctors, to readily evaluate and document treatment decisions based upon care plan records of a given patient in the patient centric system which can include the consolidated records of multiple care providers for the same patient. Patients and patient-authorized users can employ web-connected devices such as mobile phones to enter care-plan related observations, graphically display and share observations with providers, estimate adherence to care plans and the impact of care plan refinements on patient safety and quality outcomes.

The patient or legal agent thereof can authorize a variety of different health care provider's access to patient records in the patient centric system. It should be understood that one or more of the health care providers may work for or have an enterprise centric system of their own containing fragmented medical records for the same patient. The patient centric system permits the different health care providers to transmit the health records of a given patient from another enterprise centric system into the relational database(s) of the patient centric system. The patient centric system of the present invention will integrate and consolidate the records supplied by the different facilities (representing different personal care physicians and hospitals etc. of a given patient) into the patient centric system relational database(s) which becomes a depository of aggregated records from multiple sources. This is accomplished by means of software as is illustrated in FIGS. 7 and 8 respectively. In FIG. 7b three clients or patients representing client accounts 1, 2 & 3 identified by ref#134, have comprehensive records, corresponding, for example, to seven different data categories of health information inclusive of substance abuse data (ref#131), legal data (ref#132), health insurance data (ref#133), medical data (ref#128), mental health data (ref#129) and educational data (ref#127) all of which are integrated and consolidated into the single relational database ref#130. In FIG. 8a different hospitals each contain patient records in its own database for a common patient designated client 1. However since the three different hospital databases (ref# 141, 143 and 145) are only accessible independent of one another in that the data from the three different hospital databases is not interoperable, i.e., is not available for evaluated in common. In the patient centric system the data is received from all the different hospital databases and is consolidated into the patient centric system of the present invention from where all of the data from the different hospital databases can be evaluated in common and simultaneously. This is illustrated in FIG. 8b where a designated client (patient) 1, authorizes all its records ref#147, 148 and 149 from the different hospitals 1, 2 and 3 to be submitted to the patient centric system relational database (ref# 150) where it is integrated and consolidated for common evaluation and for purposes of exchange sharing by all authorized users. The comprehensive records from the client (patient) ref# 147 are shown collected at three different times in the three different hospitals with the involvement (in this example) of nine different physicians. The patient centric system permits all patient authorized users, at any time, within the limitations of their granted privileges to access all of the comprehensive records of the patient ref#147 from all of the different medical facilities once authorization is granted by the patient for electronic transfer to the patient centric system which integrates and consolidates all the data into the relational database ref# 150. The records from the enterprise centric systems represented by the different hospitals will be received by the relational database of the patent centric system as incoming data from the care providers of the different facilities and consolidated into the records of the patient. Thus the patient centric system is interoperable in that the incoming data submitted by the different caretakers or care providers from all the different enterprise centric systems is integrated and consolidated into the records of the patient in the patient centric system. This assumes authorization from the patient is granted to each different health care provider of such patient including doctors, hospitals etc. as authorized users of the patient centric system. By granting such care providers the privilege of exporting data from their enterprise centric system into the patient centric system the data from all different health care providers for a given patient can be consolidated into the records of the patient in the patient centric system.

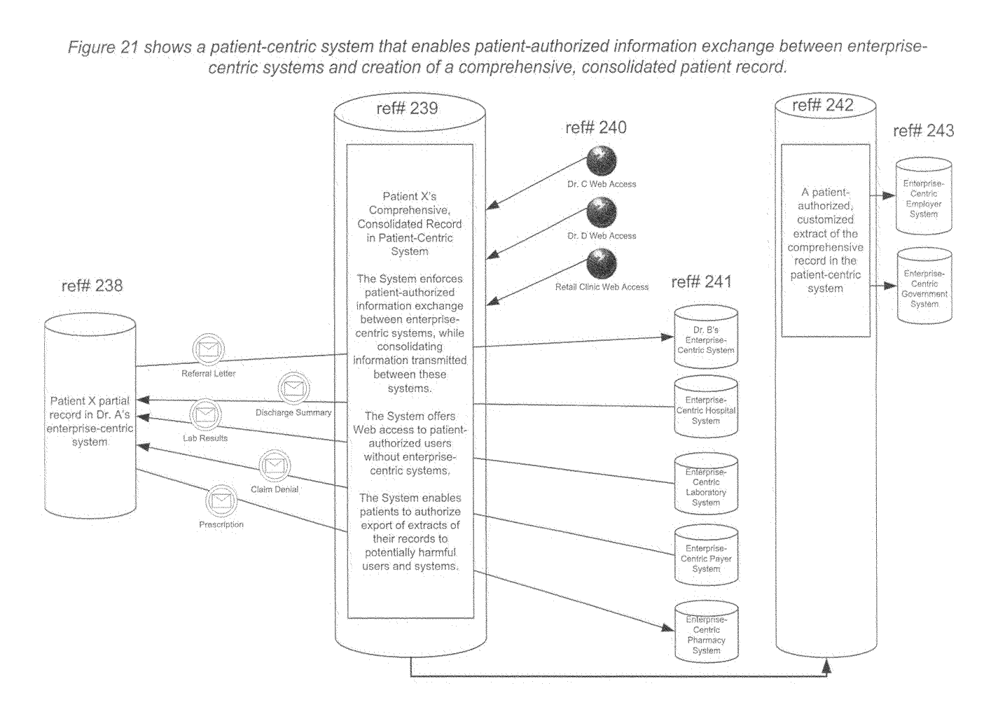

FIG. 21, consisting of ref# 238, ref#239, ref#240, ref#241, ref#242, and ref#243, shows the present invention's patient centric system, which enables patient-authorized information exchange between enterprise-centric systems and creation of a comprehensive, consolidated patient record. Ref# 238 shows Patient X's partial record in Dr. A's enterprise centric system. Ref# 241 shows Patient X's partial record in five different enterprise centric systems maintained by Dr. B, a hospital, a clinical laboratory, a pharmacy and an insurance payer. Ref# 239 shows Patient X's comprehensive, consolidated record in the patient centric system of the present invention. The patient centric system enables patient-authorized exchange of messages between the enterprise-centric systems of the patient's many current health care providers (ref# 238, ref# 241), with consolidation of all providers' messages in the patient's comprehensive record (ref# 239) and web access for current providers without enterprise-centric systems (ref# 240). Messages ordinarily transmitted between enterprise-centric systems without patient consent or knowledge such as referral letters, discharge summary, lab results, insurance claim denials and prescription orders are captured by Patient X's comprehensive record (ref# 239). Patients can authorize export of extracts of their consolidated patient records (ref# 242) to potentially harmful external organizations (ref# 243) rather than allowing wholesale unauthorized export of all patient record data contrary to patients' best interests and consent directives. In all, FIG. 20 shows the patient-centric system functioning as the hub of a patient-authorized regional health information organization including many providers whose enterprise-centric systems contain fragments of shared patients' records and including many providers without enterprise-centric systems who require another mechanism for accessing shared patients' records. The programming logic that the patient centric system employs for collection of patient information scattered in many enterprise-centric systems (FIG. 21, ref# 238, 241) and consolidation of patient information into a comprehensive patient record (FIG. 21, ref#239) is of itself conventional and well known to those skilled in the art.

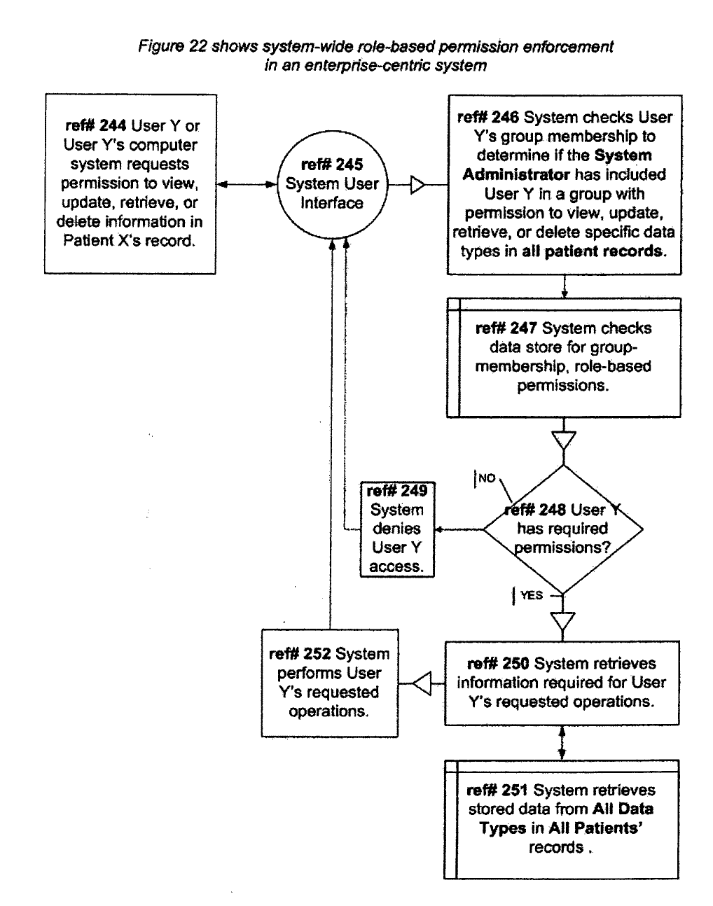

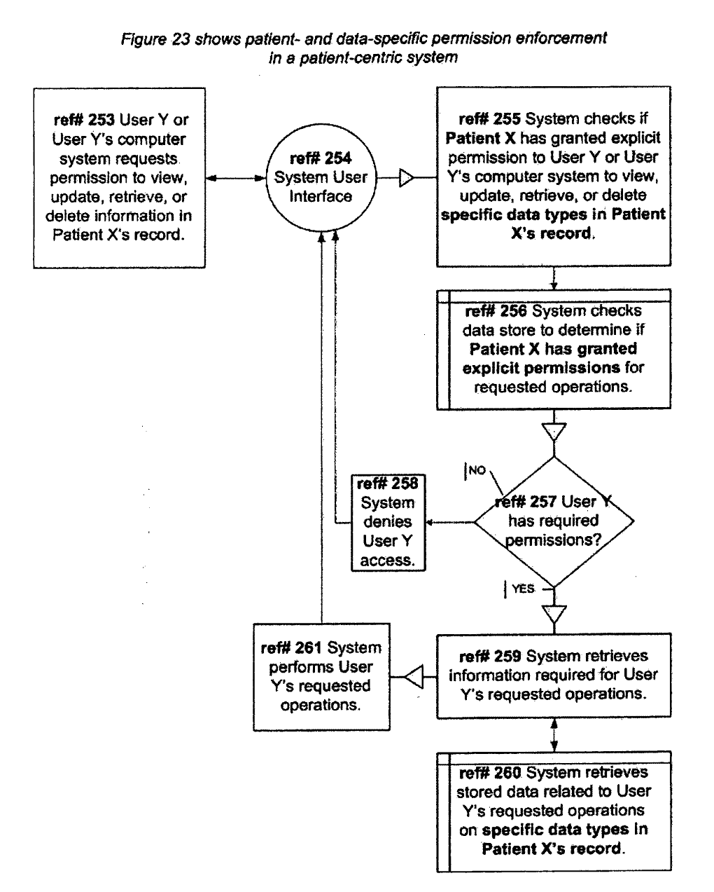

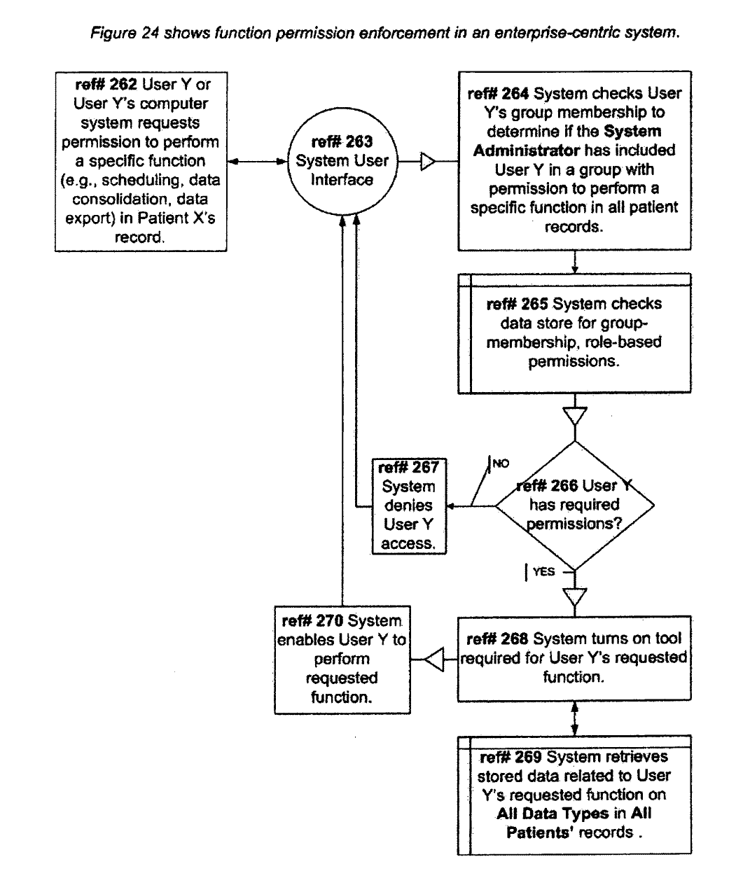

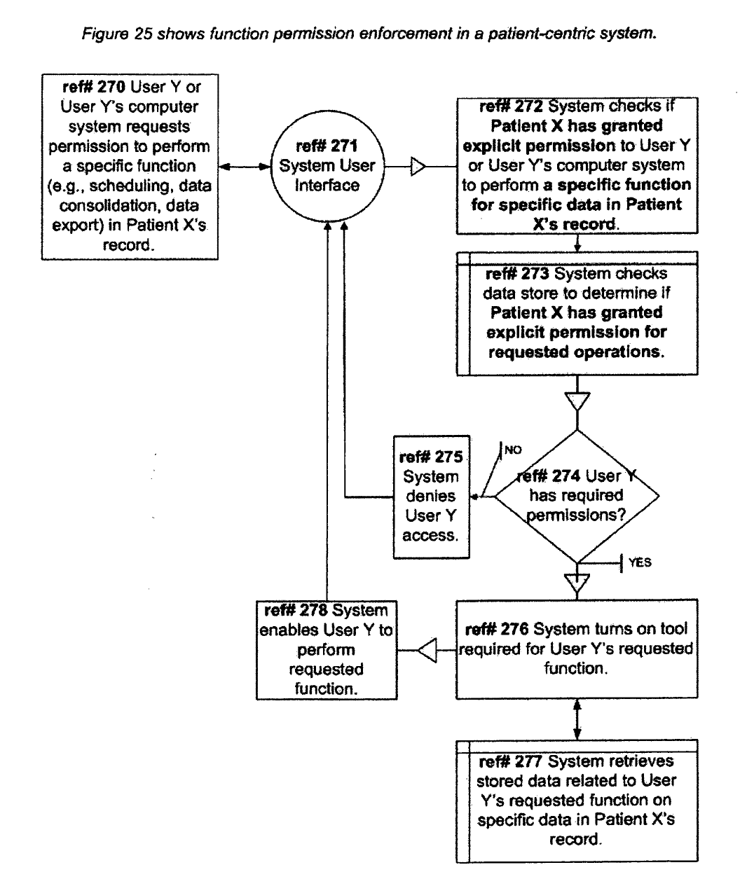

The programming logic of the patient centric system operates in real time to encode and enforce patient-authorized user permissions in accordance with each patient's current consent directives for access to a patient record, to data types within the record and to functions enabling manipulation of data within a patient record. FIG. 22 ref #246 and FIG. 24 ref #264 show that the system administrator of conventional enterprise centric systems grants so-called “blanket” permissions to groups of users for access to all patient records, all data types within those records and all functions for manipulating data within records. Patients do not control user permissions related to record, data or function access in enterprise-centric systems. The patient-centric system's programming logic assigns unique identifiers to each patient, patient-authorized user and patient-authorized computer system. When users or systems request access to records, data or functions, the patient-centric system checks the user's or the system's patient-authorized permissions before granting requested access as FIG. 23, ref# 257 and FIG. 25, ref# 274 show. In contrast, when users or systems request access to records, data or functions, in a conventional enterprise-centric system, the system checks whether the user or the system is a member of a group that the system administrator has authorized for access to all patient records, data types and functions as FIG. 22, ref# 248 and FIG. 23, ref# 266 show. As FIG. 25 ref# 275 shows, the patient-centric system enforces patient-authorized permissions for specific functions that operate on data in the patient's record such as data export, employing encryption to prevent authorized users and systems from passing along patient data to unauthorized users and systems.

The methods of programming logic that the patient centric system employs for authentication of patient-authorized users (FIG. 23 ref# 255 and FIG. 25 ref# 272), for enabling patient-authorized permissions (FIG. 23 ref#261 and FIG. 25 ref#278) and for encrypting data so as to prevent access by users and systems not authorized by patients (FIG. 23 ref#258 and FIG. 25 ref# 275) are of themselves conventional and well known to those skilled in the art and do not, independent of the way these methods are used, form part of the present invention.

What I claim is:

1. A method for accessing personal health records of a patient, stored in relational databases of a patient-centric system containing comprehensive records of multiple patients with each patient's records incorporating many different data categories and functions including manual or automated data exchange, consolidation, storage, routing and transmission, consistent with consent directives assigned to authorized users and computer systems of authorized users by the patient or designated representative thereof for defining privileges of access in each of said data categories and functions for each authorized user within the patients records, comprising the steps of:
storing consent directives assigned by the patient or designated representative thereof in each of the patient's records defining for each authorized user privileges selected from the group comprising: selective data viewing, entry, updating, consolidating, archiving, metatagging, import and export;
employing programming logic residing in the patient centric system to enforce access to patients records and to data categories and data functions within patient's records in accordance with the consent directives assigned to each authorized user;
encrypting patient's records upon storage in the relational databases and/or during transmission permitting said programming logic to enforce access to the patient's records consistent with assigned consent directives and to deny access to unauthorized users;
assigning unique identifiers to authorized users recognizable by said programming logic to enable encrypted patient records to be decrypted only by authorized users and consistent only with assigned consent directives; and
employing user interfaces to provide access to all patients and designated representatives thereof to the stored consent directives in their own records for enabling the patients and designated represented thereof to continuously monitor and modify assigned privileges in the patient's records and to withdraw the current privileges and/or initiate newly authorized privileges.

2. A method as defined in claim 2 wherein said programming logic enforces the exchange of information between authorized users relative to patient records for different patients consistent with patients consent directives for each authorized user and prohibits the transmission of data from patient records in the patient centric system to unauthorized users and from authorized used to unauthorized users.

3. A method as defined in claim 3 wherein programming logic limits downloading of data and documents only to authorized users while prohibiting the transmission of such data and documents from said authorized users to unauthorized users.

4. A method as defined in claim 2 further comprising the step of triggering an alert in response to data changes in patient records with said alert to be communicated to authorized users for emergency action.

5. A method as defined in claim 4 wherein successive alerts are triggered at given intervals in time or in a given chain of timed alerts to different authorized users.

6. A method as defined in claim 4 wherein an alarm is triggered when the alert is still outstanding either after an elapsed time interval or the non-action of a given authorized user.

7. A method as defined in claim 3 further comprising employing user interfaces to enable patients and authorized users to create coordinated action plans or care plans within patient records and to monitor plan adherence via mobile phones and other web-connected devices.

8. A method as defined in claim 7 wherein the patients and authorized users may graphically display plan adherence via mobile phones and other web connected devices and store plan related data and graphic displays in patient records for future access thereto.

9. A method as defined in claim 8 further comprising user interfaces that enable authorized users to generate diagnostic and assessment reports and to store said reports in patients records.

10. A method as defined in claim 9 further comprising user interfaces that enable authorized users to implement, coordinate, monitor and improve patient related action plans, care plans and treatment plans.

11. A method as defined in claim 3 further comprising user interfaces that enable authorized users to submit claims services and products directly to authorized insurance payer systems while automatically documenting records user payer transactions in patients records.

12. A patient-centric system for providing patients and authorized users access to patients records incorporating many different data categories and functions including manual or automated data exchange, consolidation, storage, routing and transmission, with the patients records being stored in relational databases hosted by Web servers on a computer network through which the authorized users interact under the control of programming logic consistent with consent directives, located in the patients records and assigned by the patient or designated representative thereof, defining privileges of access in each of said data categories and functions within the patients records to each authorized user, comprising:
a multi-tier system for separating the records of each patient into a multiple number of different data categories, functions and subsets thereof corresponding to multiple data elements representative of different fields of patient information;
software means in the programming logic for enforcing access to patients records and to data categories and data functions within patient's records in accordance with the consent directives assigned to each authorized user by the patient or designated representative thereof with the consent directives defining privileges selected from the group comprising; selective data viewing, entry, updating, consolidating, archiving, metatagging, import and export;
software means in the programming logic for encrypting patient's records upon storage in the relational databases and/or during transmission permitting said programming logic to enforce access to the patient's records consistent with assigned consent directives and to deny access to unauthorized users;
unique identifiers for each authorized users recognizable by said programming logic to enable encrypted patient records to be decrypted only by authorized users consistent with consent directives assigned to such authorized users; and
user interfaces for providing access in real time to all patients and designated representatives thereof to the consent directives within their own patient records for enabling the patients and designated representative thereof to continuously monitor and modify assigned privileges in the patient's records and to withdraw current privileges and/or initiate newly authorized privileges.

14- A patient-centric system as defined in claim 13 wherein said programming logic through said encryption enforces the exchange of information between authorized users relative to patient records for different patients consistent with patients consent directives for each authorized user and prohibits the transmission of data from patient records in the patient centric system to unauthorized users and from authorized used to unauthorized users.

15- A patient-centric system as defined in claim 14 further comprising user interfaces that enable patients and authorized users to create coordinated action plans or care plans within patient records and to monitor plan adherence via mobile phones and other web-connected devices.

16- A patient-centric system as defined in claim 14 further comprising a superset account recognizable by said programming logic for enforcing privileges to a plurality of users authorized to access multiple client accounts consistent with their authorized privileges and to access data aggregated across client accounts and exchange information with external devices consistent with their authorized privileges.

17- A patient-centric system as defined in claim 14 wherein said programming logic includes a software routine permitting a plurality of different authorized users to consolidate records from sources outside the patient centric system into the patients records within the relational databases in the patient centric system consistent with patients consent directives for each authorized user.
